(19) United States
(12) Patent Application Publication
(10) Pub. No.: US 2010/0004010 A1
(43) Pub. Date: Jan. 7, 2010

(54) MOBILE TERMINAL AND FILE TRANSMISSION METHOD THEREOF

(76) Inventors: Joon-Hun SHIN, Gyeonggi-Do (KR); Sang-Min LEE, Seoul (KR); Hwan-Goo PARK, Seoul (KR)

Correspondence Address: BIRCH STEWART KOLASCH & BIRCH, PO BOX 747, FALLS CHURCH, VA, 22040-0747, US

(21) Appl. No.: 12/496,711

(22) Filed: Jul. 2, 2009

(30) Foreign Application Priority Data
Jul. 4, 2008 (KR) 10-2008-0065100

(51) Int. Cl. H04W 4/12

(52) U.S. Cl. 455/466

(57) ABSTRACT

A mobile terminal that can transmit voice data an picture, as well as a text message, in the form of a file during an instant messaging (IM) service, and its file transmission method are disclosed. When the IM service starts, a user inputs text to a message window to chat with one or more subscribers, and when voice or image data (picture, handwriting, image, etc.) is inputted while text is inputted, the inputted voice or image data is converted into a file, transmitted to a counterpart subscriber, and displayed in the form of an icon on a message window. The counterpart subscriber can check the voice or picture by selecting the displayed icon.

### CROSS REFERENCE TO RELATED APPLICATIONS

The present application claims priority to Korean Application No. 10-2008-0065100 filed in Korea on Jul. 4, 2008, the entire contents of which is hereby incorporated by reference in its entirety.

### BACKGROUND OF THE INVENTION

1. Field of the Invention

The present invention relates to an instant messaging (IM) service of a mobile terminal and, more particularly, to a mobile terminal capable of transmitting voice and picture (i.e., drawing) data during IM, and its file transmission method.

2. Description of the Related Art

A mobile terminal may be configured to perform diverse functions. Examples of such functions include data and voice communications, capturing images and video via a camera, recording audio, playing music files via a speaker system, and displaying images and video on a display. Some terminals include additional functionality which supports game playing, while other terminals are configured as multimedia players. More recently, mobile terminals have been configured to receive broadcast and multicast signals which permit viewing of content such as videos and television programs.

Also, efforts are ongoing to support and increase the functionality of mobile terminals. Such efforts include software and hardware improvements, as well as changes and improvements in the structural components which form the mobile terminal. Among them, a touch function of mobile terminals allow users, who are not familiar to button/key inputs, to conveniently operate the terminals by using a touch screen, and as such, the touch function is increasingly considered as a significant, major function of terminals along with a user interface (U) besides simple inputs.

An instant messaging (IM) service supports real time communications allowing users in an online state on the Internet or IP to send simple messages (notes, files, data, etc.) in real time, like chatting or phone calls. In the IM service, immediately when a user sends a message, the message is outputted to a screen of a counterpart (e.g., another party), enabling real time communications like chatting or phone calls. Thus, with the IM service, the user can transmit or receive a message in real time in a wireline/wireless network and immediately check whether or not the message has been received.

In order to use the IM service, subscribers (e.g., users) must install an IM program in their communication device (e.g., computers, mobile terminals, etc.) and register a list of those with which the users want to communicate (i.e., list of friends, buddies, etc.). Once the list of friends is registered, users can recognize whether or not the counterpart(s) have been connected to the wireline/wireless network and immediately talk with them by simply clicking, or may send data.

### SUMMARY OF THE INVENTION

Accordingly, one object of the present invention is to address the above-noted and other problems.

Another object of the present invention is to provide a mobile terminal capable of transmitting voice data and picture data (i.e., drawing, etc.) in a file format during an instant messaging (IM) service, and a file transmission method of the mobile terminal.

Another object of the present invention is to provide a mobile terminal capable of displaying voice or picture icons regarding a received file on a receiver side message (or chat) window to simply reproduce the file, and a file transmission method of the mobile terminal.

To achieve these and other advantages and in accordance with the purpose of the present invention, as embodied and broadly described herein, the present invention provides in one aspect a mobile terminal including: a display unit configured to display a message window to perform an IM service; an input unit configured to input voice data or image data; and a controller configured to allow a user to chat by text with a counterpart subscriber on the message window, and convert the voice data or image data inputted during the IM service into files and transmit the files to the counterpart subscriber.

The image data may include a picture, a handwriting, and a screen image.

When only the IM service is provided, the voice data may be voice data of a transmitter side, and when the IM service is provided during voice call communication, the voice data may include one of the voice data of the transmitter side, voice data of a receiver side, and the voice data of the transmitter side and the voice data of the receiver side. When the IM service is provided during video call communication, files are made for voice data of the transmitter side, for voice data plus image data of the transmitter side, for the voice data of the transmitter side plus the voice data and image data of the receiver side, and for voice data and image data of the receiver side.

The voice data may be immediately recorded when a certain key is pressed or a touch input is applied, and when an emoticon of a counterpart is selected, the voice data may be immediately recorded and transmitted.

For the voice data file or the image data file, the controller may set a storage/non-storage item as to whether such should be stored at the receiver side. The storage/non-storage item may include an item for immediately outputting received voice data or image data, an item for displaying the received voice data or image data in the form of an icon without outputting the received voice data or image data, and an item for outputting the received voice data and image data one time and displaying the received voice data and image data in the form of icon.

To achieve these and other advantages and in accordance with the purpose of the present invention, as embodied and broadly described herein, the present invention provides in another aspect a method for inputting information of a mobile terminal in an IM service, including: when an IM service starts, displaying a message window; chatting by text with one or more subscribers on the message window; inputting voice data or image data while inputting text; and converting the inputted voice data or image data into files and transmitting the voice file or image file to the counterpart subscribers.

The image data may include a picture, a handwriting, and a screen image.

When only the IM service is provided, the voice data may be voice data of a transmitter side, and when the IM service is provided during voice call communication, the voice data may include one of the voice data of the transmitter side, voice data of a receiver side, and the voice data of the transmitter side and the voice data of the receiver side. When the IM service is provided during video call communication, files are made for voice data of the transmitter side, for voice data plus image data of the transmitter side, for the voice data of the transmitter side plus the voice data and image data of the receiver side, and for voice data and image data of the receiver side.

The voice data may be immediately recorded when a certain key is pressed or a touch input is applied, and when an emoticon of a counterpart is selected, the voice data may be immediately recorded and transmitted.

For the voice data file or the image data file, a storage/non-storage item may be set as to whether such should be stored at the receiver side. The storage/non-storage item may include an item for immediately outputting received voice data or image data, an item for displaying the received voice data or image data in the form of an icon without outputting the received voice data or image data, and an item for outputting the received voice data and image data one time and displaying the received voice data and image data in the form of icon.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1 is a schematic block diagram of a mobile terminal according to an exemplary embodiment of the present invention;

FIG. 2 is a front perspective view of a mobile terminal according to an exemplary embodiment of the present invention;

FIG. 3 is a rear perspective view of a mobile terminal according to an exemplary embodiment of the present invention;

FIG. 4 is a block diagram of a wireless communication system with which the mobile terminal according to an exemplary embodiment of the present invention is operable;

FIG. 5 is an overview of a display screen illustrating A general instant messaging (IM) service;

FIG. 6 is an overview of a display screen illustrating chatting by text between designated particular subscribers in FIG. 5;

FIG. 7 is a flow chart illustrating a message transmission between two subscribers of an IM service according to an exemplary embodiment of the present invention;

FIG. 8 is a flow chart illustrating a file transmission method of a mobile terminal in an IM service according to an exemplary embodiment of the present invention;

FIG. 9 is overviews of display screens illustrating a voice transmission method during an IM service according to an exemplary embodiment of the present invention;

FIG. 10 is overviews of display screens illustrating inputting and transmitting an image during an IM service according to an exemplary embodiment of the present invention;

FIG. 11 is a flow chart illustrating the process of generating a voice file during an IM service according to an exemplary embodiment of the present invention;

FIG. 12 is a flow chart illustrating the process of a method of displaying a reception file at a receiver side according to an exemplary embodiment of the present invention;

FIG. 13 is overviews of display screens illustrating a reception file at the receiver side according to an exemplary embodiment of the present invention; and

FIG. 14 is overviews of display screens illustrating utilization of a method of inputting and transmitting an image during an IM service according to an exemplary embodiment of the present invention.

### DETAILED DESCRIPTION OF THE INVENTION

The mobile terminal according to exemplary embodiments of the present invention will now be described with reference to the accompanying drawings. In the following description, usage of suffixes such as ‘module’, ‘part’ or ‘unit’ used for referring to elements is given merely to facilitate explanation of the present invention, without having any significant meaning by itself. Accordingly, the ‘module’ and ‘part’ may be mixedly used.

Mobile terminals may be implemented in various forms. For example, the terminal described in the present invention may include mobile terminals such as mobile phones, smart phones, notebook computers, digital broadcast receivers, PDAs (Personal Digital Assistants), PMPs (Portable Multimedia Player), navigation devices, and the like, and fixed terminals such as digital TVs, desk top computers and the like. Hereinafter, it is assumed that the terminal is a mobile terminal. However, it would be understood by a person in the art that the configuration according to the embodiments of the present invention can be also applicable to the fixed types of terminals, except for any elements especially configured for a mobile purpose.

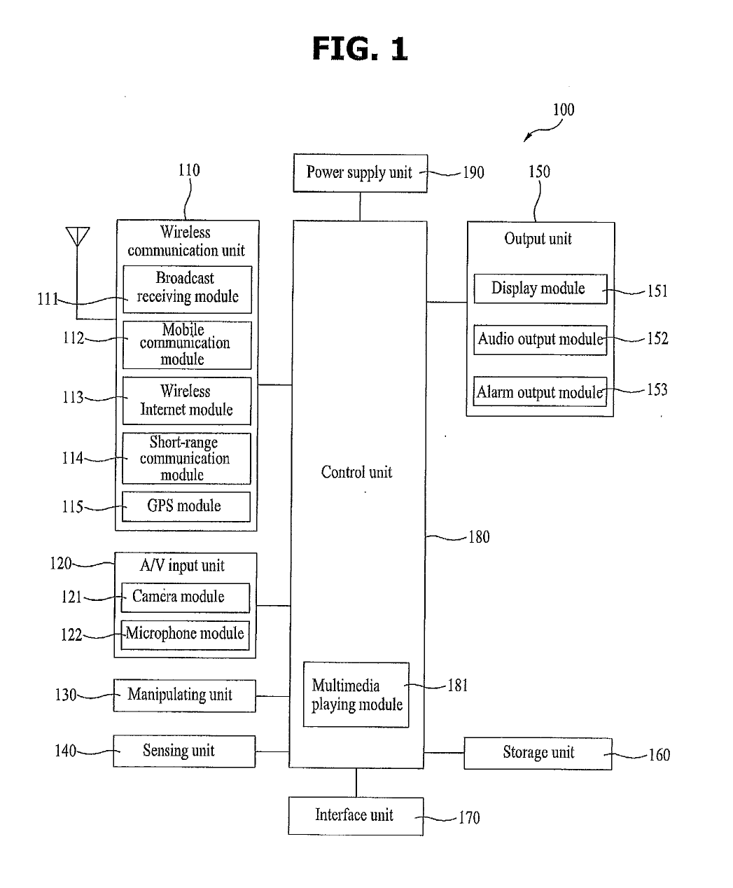

FIG. 1 is a block diagram of a mobile terminal according to an embodiment of the present invention.

The mobile terminal 100 may include a wireless communication unit 110, an A/V (Audio/Video) input unit 120, a user input unit 130, a sensing unit 140, an output unit 150, a memory 160, an interface unit 170, a controller 180, and a power supply unit 190, etc. FIG. 1 shows the mobile terminal as having various components, but it should be understood that implementing all of the illustrated components is not a requirement. Greater or fewer components may alternatively be implemented.

The elements of the mobile terminal will be described in detail as follows.

The wireless communication unit 110 typically includes one or more components allowing radio communication between the mobile terminal 100 and a wireless communication system or a network in which the mobile terminal is located. For example, the wireless communication unit may include at least one of a broadcast receiving module 111, a mobile communication module 112, a wireless Internet module 113, a short-range communication module 114, and a location information module 115.

The broadcast receiving module 111 receives broadcast signals and/or broadcast associated information from an external broadcast management server (or other network entity) via a broadcast channel. The broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast signal may include a TV broadcast signal, a radio broadcast signal, a data broadcast signal, and the like. Also, the broadcast signal may further include a broadcast signal combined with a TV or radio broadcast signal.

The broadcast associated information may also be provided via a mobile communication network and, in this case, the broadcast associated information may be received by the mobile communication module 112.

The broadcast signal may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may be configured to receive signals broadcast by using various types of broadcast systems. In particular, the broadcast receiving module 111 may receive a digital broadcast by using a digital broadcast system such as multimedia broadcasting-terrestrial (DMB-T), digital multimedia broadcasting-satellite (DMB-S), digital video broadcast-handheld (DVB-H), the data broadcasting system known as media forward link only (MediaFLO®), integrated services digital broadcast-terrestrial (ISDB-T), etc. The broadcast receiving module 111 may be configured to be suitable for every broadcast system that provides a broadcast signal as well as the above-mentioned digital broadcast systems.

Broadcast signals and/or broadcast-associated information received via the broadcast receiving module 111 may be stored in the memory 160 (or anther type of storage medium).

The mobile communication module 112 transmits and/or receives radio signals to and/or from at least one of a base station (e.g., access point, Node B, etc.), an external terminal (e.g., other user devices) and a server (or other network entities). Such radio signals may include a voice call signal, a video call signal or various types of data according to text and/or multimedia message transmission and/or reception.

The wireless Internet module 113 supports wireless Internet access for the mobile terminal. This module may be internally or externally coupled to the terminal. The wireless Internet access technique implemented may include a WLAN (Wireless LAN) (Wi-Fi), Wibro (Wireless broadband), Wimax (World Interoperability for Microwave Access), HSDPA (High Speed Downlink Packet Access), or the like.

The short-range communication module 114 is a module for supporting short range communications. Some examples of short-range communication technology include Bluetooth™, Radio Frequency IDentification (RFID), Infrared Data Association (IrDA), Ultra-WideBand (UWB), ZigBee™, and the like.

The location information module 115 is a module for checking or acquiring a location (or position) of the mobile terminal. A typical example of the location information module is a GPS (Global Positioning System). According to the current technology, the GPS module 115 calculates distance information from three or more satellites and accurate time information and applies trigonometry to the calculated information to thereby accurately calculate three-dimensional current location information according to latitude, longitude, and altitude. Currently, a method for calculating location and time information by using three satellites and correcting an error of the calculated location and time information by using another one satellite. In addition, the GPS module 115 can calculate speed information by continuously calculating the current location in real time.

The A/V input unit 120 is configured to receive an audio or video signal. The A/V input unit 120 may include a camera 121 (or other image capture device) and a microphone 122 (or other sound pick-up device). The camera 121 processes image data of still pictures or video obtained by an image capture device in a video capturing mode or an image capturing mode. The processed image frames may be displayed on a display unit 151 (or other visual output device).

The image frames processed by the camera 121 may be stored in the memory 160 (or other storage medium) or transmitted via the wireless communication unit 110. Two or more cameras 121 may be provided according to the configuration of the mobile terminal.

The microphone 122 may receive sounds (audible data) via a microphone (or the like) in a phone call mode, a recording mode, a voice recognition mode, and the like, and can process such sounds into audio data. The processed audio (voice) data may be converted for output into a format transmittable to a mobile communication base station (or other network entity) via the mobile communication module 112 in case of the phone call mode. The microphone 122 may implement various types of noise canceling (or suppression) algorithms to cancel (or suppress) noise or interference generated in the course of receiving and transmitting audio signals.

The user input unit 130 (or other user input device) may generate key input data from commands entered by a user to control various operations of the mobile terminal. The user input unit 130 allows the user to enter various types of information, and may include a keypad, a dome switch, a touch pad (e.g., a touch sensitive member that detects changes in resistance, pressure, capacitance, etc. due to being contacted) a jog wheel, a jog switch, and the like. In particular, when the touch pad is overlaid on the display unit 151 in a layered manner, it may form a touch screen.

The sensing unit 140 (or other detection means) detects a current status (or state) of the mobile terminal 100 such as an opened or closed state of the mobile terminal 100, a location of the mobile terminal 100, the presence or absence of user contact with the mobile terminal 100 (i.e., touch inputs), the orientation of the mobile terminal 100, an acceleration or deceleration movement and direction of the mobile terminal 100, etc., and generates commands or signals for controlling the operation of the mobile terminal 100. For example, when the mobile terminal 100 is implemented as a slide type mobile phone, the sensing unit 140 may sense whether the slide phone is opened or closed. In addition, the sensing unit 140 can detect whether or not the power supply unit 190 supplies power or whether or not the interface unit 170 is coupled with an external device. The sensing unit 140 may include a proximity sensor 141. This will be described in relation to a touch screen later.

The interface unit 170 (or other connection means) serves as an interface by which at least one external device may be connected with the mobile terminal 100. For example, the external devices may include wired or wireless headset ports, an external power supply (or battery charger) ports, wired or wireless data ports, memory card ports, ports for connecting a device having an identification module, audio input/output (I/O) ports, video I/O ports, earphone ports, or the like.

The identification module may be a memory chip (or other element with memory or storage capabilities) that stores various information for authenticating user's authority for using the mobile terminal 100 and may include a user identity module (UIM), a subscriber identity module (SIM) a universal subscriber identity module (USIM), and the like. In addition, the device having the identification module (referred to as the ‘identifying device’, hereinafter) may take the form of a smart card. Accordingly, the identifying device may be connected with the terminal 100 via a port or other connection means. The interface unit 170 may be used to receive inputs (e.g., data, information, power, etc.) from an external device and transfer the received inputs to one or more elements within the mobile terminal 100 or may be used to transfer data between the mobile terminal and an external device.

The output unit 150 is configured to provide outputs in a visual, audible, and/or tactile manner (e.g., audio signal, video signal, alarm signal, vibration signal, etc.). The output unit 150 may include the display unit 151, an audio output module 152, an alarm unit 153, and the like.

The display unit 151 may display information processed in the mobile terminal 100. For example, when the mobile terminal 100 is in a phone call mode, the display unit 151 may display a User Interface (UI) or a Graphic User Interface (GUI) associated with a call or other communication (such as text messaging, multimedia file downloading, etc.). When the mobile terminal 100 is in a video call mode or image capturing mode, the display unit 151 may display a captured image and/or received image, a UI or GUI that shows videos or images and functions related thereto, and the like.

Meanwhile, when the display unit 151 and the touch pad are overlaid in a layered manner to form a touch screen, the display unit 151 may function as both an input device and an output device. The display unit 151 may include at least one of a Liquid Crystal Display (LCD), a Thin Film Transistor-LCD (TFT-LCD), an Organic Light Emitting Diode (OLED) display, a flexible display, a three-dimensional (3D) display, or the like. Some of them may be configured to be transparent to allow viewing of the exterior, which may be called transparent displays. A typical transparent display may be, for example, a TOLED (Transparent Organic Light Emitting Diode) display, or the like. The mobile terminal 100 may include two or more display units (or other display means) according to its particular desired embodiment. For example, the mobile terminal may include both an external display unit (not shown) and an internal display unit (not shown). The touch screen may be configured to detect even a touch input pressure as well as a touch input position and a touch input area.

A proximity sensor 141 may be disposed within or near the touch screen. The proximity sensor 141 is a sensor for detecting the presence or absence of an object relative to a certain detection surface or an object that exists nearby by using the force of electromagnetism or infrared rays without a physical contact. Thus, the proximity sensor 141 has a considerably longer life span compared with a contact type sensor, and it can be utilized for various purposes.

Examples of the proximity sensor 141 may include a transmission type photoelectric sensor, a direct reflection type photoelectric sensor, a mirror-reflection type photo sensor, an RF oscillation type proximity sensor, a capacitance type proximity sensor, a magnetic proximity sensor, an infrared proximity sensor, and the like.

The operational principle of the RF oscillation type proximity sensor, among the implementable proximity sensors, will be described as an example. When an object approaches the sensor detection surface in a state that an RF (Radio Frequency) of a static wave is oscillated by an oscillation circuit, the oscillation amplitude of the oscillation circuit is attenuated or stopped, and such a change is converted into an electrical signal to detect the presence or absence of an object. Thus, even if any material other than metallic one is positioned between the RF oscillation proximity sensor and the object, a proximity switch can detect the object intended to be detected without an interference by the object.

Without the proximity sensor 141, if the touch screen is an electrostatic type, the approach of a pointer (stylus) can be detected based on a change in a field according to the approach of the pointer.

Thus, although the pointer is not actually brought into contact with the touch screen but merely positioned close to the touch screen, the position of the pointer and the distance between the pointer and the touch screen can be detected. In the following description, for the sake of brevity, recognition of the pointer positioned to be close to the touch screen will be called a ‘proximity touch’, while recognition of actual contacting of the pointer on the touch screen will be called a ‘contact touch’. In this case, when the pointer is in the state of the proximity touch, it means that the pointer is positioned to correspond vertically to the touch screen.

By employing the proximity sensor 141, a proximity touch and a proximity touch pattern (e.g., a proximity touch distance, a proximity touch speed, a proximity touch time, a proximity touch position, a proximity touch movement state, or the like) can be detected, and information corresponding to the detected proximity touch operation and the proximity touch pattern can be outputted to the touch screen.

The audio output module 152 may convert and output as sound audio data received from the wireless communication unit 110 or stored in the memory 160 in a call signal reception mode, a call mode, a record mode, a voice recognition mode, a broadcast reception mode, and the like. Also, the audio output module 152 may provide audible outputs related to a particular function performed by the mobile terminal 100 (e.g., a call signal reception sound, a message reception sound, etc.). The audio output module 152 may include a speaker, a buzzer, or other sound generating device.

The alarm unit 153 (or other type of user notification means) may provide outputs to inform about the occurrence of an event of the mobile terminal 100. Typical events may include call reception, message reception, key signal inputs, a touch input etc. In addition to audio or video outputs, the alarm unit 153 may provide outputs in a different manner to inform about the occurrence of an event. For example, the alarm unit 153 may provide an output in the form of vibrations (or other tactile or sensible outputs). When a call, a message, or some other incoming communication is received, the alarm unit 153 may provide tactile outputs (i.e., vibrations) to inform the user thereof. By providing such tactile outputs, the user can recognize the occurrence of various events even if his mobile phone is in the user's pocket. Outputs informing about the occurrence of an event may be also provided via the display unit 151 or the audio output module 152.

The memory 160 (or other storage means) may store software programs or the like used for the processing and controlling operations performed by the controller 180, or may temporarily store data (e.g., a phonebook, messages, still images, video, etc.) that have been outputted or which are to be outputted. Also, the memory 160 may store data regarding various patterns of vibrations and audio signals outputted when a touch is applied to the touch screen.

The memory 160 may include at least one type of storage medium including a Flash memory, a hard disk, a multimedia card, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, an optical disk, and the like. Also, the mobile terminal 100 may cooperate with a network storage device that performs the storage function of the memory 160 over a network connection.

The controller 180 (such as a microprocessor or the like) typically controls the general operations of the mobile terminal. For example, the controller 180 performs controlling and processing associated with voice calls, data communications, video calls, and the like. In addition, the controller 180 may include a multimedia module 181 for reproducing (or playing back) multimedia data. The multimedia module 181 may be configured within the controller 180 or may be configured to be separate from the controller 180.

The controller 180 may perform a pattern recognition processing to recognize a handwriting input or a picture drawing input performed on the touch screen as characters or images.

The power supply unit 190 receives external power (via a power cable connection) or internal power (via a battery of the mobile terminal) and supplies appropriate power required for operating respective elements and components under the control of the controller 180.

Various embodiments as described herein may be implemented in a computer-readable medium using, for example, computer software, hardware, or any combination thereof.

For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented in the controller 180.

For software implementation, the embodiments such as procedures or functions may be implemented together with separate software modules that allow performing of at least one function or operation. Software codes can be implemented by a software application (or program) written in any suitable programming language. The software codes may be stored in the memory 160 and executed by the controller 180.

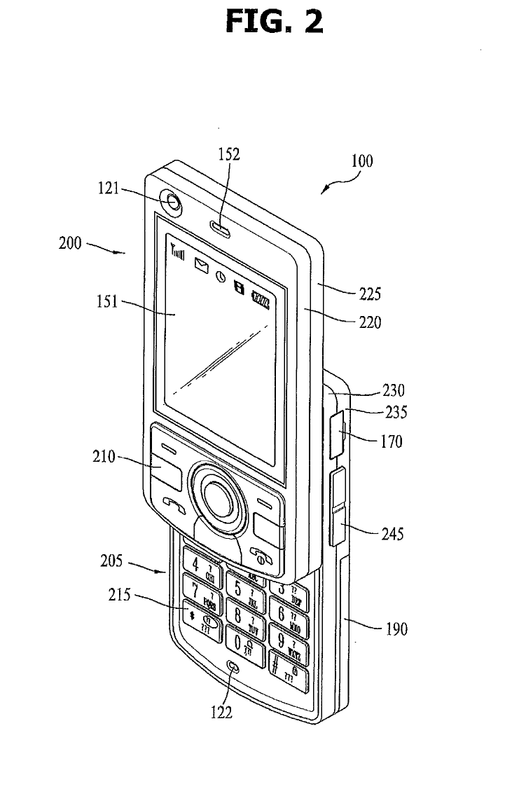

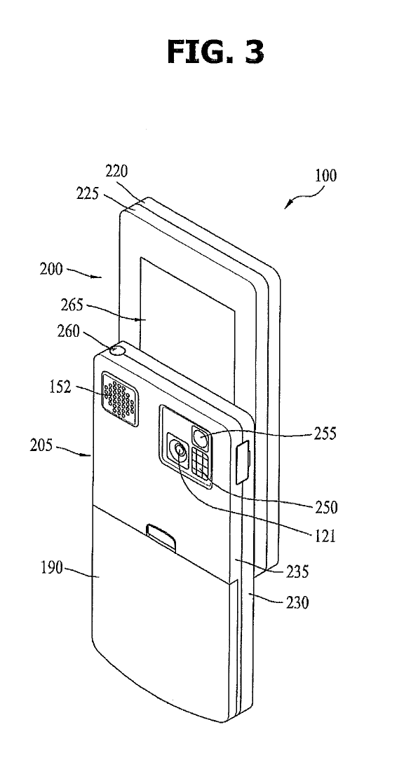

So far, the mobile terminal has been described from the perspective of its functions. Hereinafter, external elements of the mobile terminal will be described from the perspective of their functions with reference to FIGS. 2 and 3. The mobile terminal may be implemented in a variety of different configurations. Examples of such configurations include folder-type, bar-type, swing-type, a slide type, as well as various other configurations. The following description will primarily relate to a slide-type mobile terminal. However, such description can equally apply to other types of mobile terminals.

FIG. 2 is a front perspective view of the mobile terminal according to an exemplary embodiment of the present invention.

The mobile terminal 100 according to the present invention includes a first body 200, and a second body 205 that can be slidably moved along at least one direction with respect to the first body 200. In case of a folder type mobile phone, the mobile terminal 100 may include a first body and a second body having one side that can be folded or unfolded with respect to the first body.

A state in which the first body 200 is disposed to overlap with the second body 205 may be called a closed configuration, and as shown in FIG. 2, a state in which at least a portion of the second body 205 is exposed may be called an open configuration.

Although not shown, the mobile terminal according to the present invention may be a folder type mobile terminal including a first body and a second body having one side to be folded or unfolded with respect to the first body. Here, a state in which the second body is folded may be called a closed configuration, and a state in which the second body is unfolded may be called an open configuration.

In addition, although not shown, the mobile terminal according to the present invention may be a swing type mobile terminal including a first body and a second body configured to be swingable with respect to the first body. Here, a state in which the first body is disposed to overlap with the second body may be called a closed configuration, and a state in which the second body is swung to expose a portion of the first body may be called an open configuration.

The folder type mobile terminal and the swing type mobile terminal can be easily know by the person in the art without any explanation, so its detailed description will be omitted.

In the closed configuration, the mobile terminal 100 mainly operates in a standby (or idle) mode, and the standby mode may be released upon user manipulation. The mobile terminal operates mainly in the calling mode or the like in the open configuration, and it can be changed to the standby mode with the lapse of time or upon user manipulation.

The case (or casing, housing, cover, etc.) constituting the external appearance of the first body 200 may include a first front case 220 and a first rear case 225. Various electronic components are installed in the space between the first front case 220 and the first rear case 225. One or more intermediate cases may be additionally disposed between the first front case 220 and the first rear case 225.

The cases may be formed by injection-molding a synthetic resin or may be made of a metallic material such as stainless steel (STS) or titanium (Ti), etc.

The display unit 151, the audio output module 152, the camera 121 or the first user input unit 210 may be located at the first body 200, specifically, on the first front case 220 of the first body 200.

The display unit 151 has been described in relation to FIG. 1, so its detailed description will be omitted for the sake of brevity.

The audio output unit 152 may be implemented in the form of a speaker or other sound producing device.

The camera 121 may be implemented to be suitable for capturing images or video with respect to the user and other objects.

Like the first body 200, the case constituting the external appearance of the second body 205 may include a second front case 230 and a second rear case 235.

A second user input unit 215 may be disposed at the second body, specifically, at a front face of the second body 205.

A third user input unit 245, the microphone 122, and the interface unit 170 may be disposed on at least one of the second front case 230 and the second rear case 235.

The first to third user input units 210, 215 and 245 may be generally referred to as a manipulating portion 130, and various methods and techniques can be employed for the manipulation unit so long as they can be operated by the user in a tactile manner.

For example, the user input units 130 can be implemented as dome switches, actuators, or touch pad regions that can receive user commands or information according to the user's touch operations (e.g., pressing, pushing, swiping, drag-and-drop, etc.) or may be implemented in the form of a rotatable control wheel (or disc), keys or buttons, a jog dial, a joystick, or the like.

In terms of their functions, the first user input unit 210 is used for inputting (entering) commands such as start, end, scroll or the like, and the second user input unit 215 is used for inputting (entering) numbers, characters, symbols, or the like. The first user input unit 210 may include a soft key used by interworking with icons displayed on the display unit 151 and navigation key (largely including four direction keys and a central key) for indicating and checking directions.

Also, the third user input unit 245 may support the so-called hot key functions that allow more convenient activation of particular functions for the mobile terminal.

The microphone 122 (or other sound pick-up device) may be appropriately implemented to detect user voice inputs, other sounds, and the like.

The interface unit 170 may be used as a communication link (or passage, path, etc.) through which the terminal can exchange data or the like with an external device. The interface unit 170 has been described in relation to FIG. 1, so its detailed description will be omitted.

The power supply unit 190 for supplying power to the terminal may be located at the second rear case 235.

The power supply unit 190 may be, for example, a rechargeable battery that can be detached.

FIG. 3 is a rear perspective view of the mobile terminal of FIG. 2 according to an exemplary embodiment.

As shown in FIG. 3, a camera 121 (or other image pick-up device) may additionally be disposed on a rear surface of the second rear case 235 of the second body 205. The camera 121 of the second body 205 may have an image capture direction which is substantially opposite to that of the camera 121 of the first body 200 (namely, the two cameras may be implemented to face towards opposing directions, such as front and rear), and may support a different number of pixels (i.e., have a different resolution) than the camera 121 of the first body.

For example, the camera of the first body 200 may operate with a relatively lower resolution to capture an image(s) of the user's face and immediately transmit such image(s) to another party in real-time during video call communication or the like in which reverse link bandwidth capabilities may be limited. Also, the camera of the second body 205 may operate with a relatively higher resolution to capture images of general objects with high picture quality, which may not require immediately transmission in real-time, but may be stored for later viewing or use.

Additional camera related components, such as a flash 250 and a mirror 255, may be additionally disposed adjacent to the camera 121. When an image of the subject is captured with the camera 121 of the second body 205, the flash 250 illuminates the subject. The mirror 255 allows the user to see himself when he wants to capture his own image (i.e., self-image capturing) by using the camera 121 of the second body 205.

The second rear case 235 may further include an audio output module 152.

The audio output module 152 of the second body 205 may support stereophonic sound functions in conjunction with the audio output module 152 of the first body 200 and may be also used for sending and receiving calls in a speaker phone mode.

A broadcast signal receiving antenna 260 may be disposed (externally or internally) at one side or region of the second rear case 235, in addition to an antenna that is used for mobile communications. The antenna 260 can also be configured to be retractable from the second body 205.

One part of a slide module 265 that allows the first body 200 and the second body 205 to slide relative to each other may be disposed on the first rear case 225 of the first body 200.

The other part of the slide module 265 may be disposed on the second front case 230 of the second body 205, which may not be exposed as shown in the drawing.

The second camera 121 and other components may be disposed on the second body 205, but such configuration is not meant to be limited.

For example, one or more of the elements (e.g., 260, 121 and 250 and 152 etc.), which are disposed on the second rear case 235 may be mounted on the first body 200, mainly, on the first rear case 225. In this case, those elements disposed on the first rear case 225 can be protected (or covered) by the second body 205 in the closed configuration. In addition, even if a separate camera is not provided at the second body, the camera module 121 may be configured to rotate (or otherwise be moved) to thus allow image capturing in various directions.

The mobile terminal 100 as shown in FIGS. 1 to 3 may be configured to operate with a communication system, which transmits data via frames or packets, such as wired and wireless communication systems, as well as satellite-based communication systems.

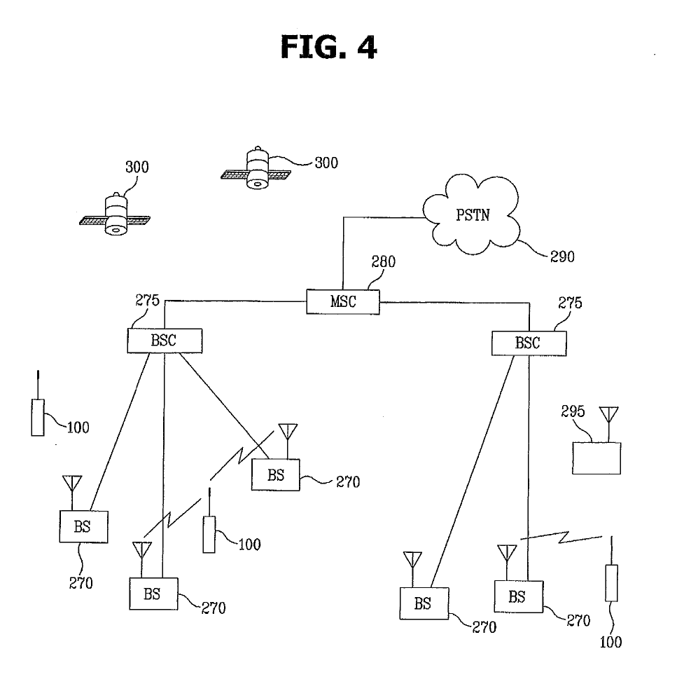

Such communication systems in which the mobile terminal according to the present invention can operate will now be described with reference to FIG. 4.

Such communication systems may use different air interfaces and/or physical layers. For example, air interfaces utilized by the communication systems include example, frequency division multiple access (FDMA), time division multiple access (TDMA), code division multiple access (CDMA), and universal mobile telecommunications system (UMTS) (in particular, long term evolution (LTE)), global system for mobile communications (GSM), and the like. As a non-limiting example, the description hereafter relates to a CDMA communication system, but such teachings apply equally to other types of systems.

Referring to FIG. 4, a CDMA wireless communication system may include a plurality of mobile terminals 100, a plurality of base stations (BSs) 270, base station controllers (BSCs) 275, and a mobile switching center (MSC) 280. The MSC 280 is configured to interface with a public switch telephone network (PSTN) 290. The MSC 280 is also configured to interface with the BSCs 275, which may be coupled to the base stations 270 via backhaul lines. The backhaul lines may be configured in accordance with any of several known interfaces including, for example, E1/T1, ATM, IP, PPP, Frame Relay, HDSL, ADSL, or XDSL. It is to be understood that the system as shown in FIG. 4 may include a plurality of BSCs 275.

Each BS 270 may serve one or more sectors (or regions), each sector covered by an omni-directional antenna or an antenna pointed in a particular direction radially away from the BS 270. Alternatively, each sector may be covered by two or more antennas for diversity reception. Each BS 270 may be configured to support a plurality of frequency assignments, and each frequency assignment has a particular spectrum (e.g., 1.25 MHz, 5 MHz, etc).

The intersection of a sector and frequency assignment may be referred to as a CDMA channel. The BS 270 may also be referred to as base station transceiver subsystems (BTSs) or other equivalent terms. In such case, the term “base station” may be used to collectively refer to a single BSC 275 and at least one BS 270. The base station may also be referred to as a “cell site”. Alternatively, individual sectors of a particular BS 270 may be referred to as a plurality of cell sites.

As shown in FIG. 4, a broadcasting transmitter (BT) 295 transmits a broadcast signal to the mobile terminals 100 operating within the system. The broadcast receiving module 111 as shown in FIG. 1 is provided at the terminal 100 to receive broadcast signals transmitted by the BT 295. In FIG. 4, several global positioning systems (GPS) satellites 300 are shown. The satellites 300 help locate at least one of a plurality of terminals 100. In FIG. 4, several satellites 300 are depicted, but it is understood that useful positioning information may be obtained with any number of satellites. The GPS module 115 as shown in FIG. 1 is typically configured to cooperate with the satellites 300 to obtain desired positioning information. Instead of or in addition to GPS tracking techniques, other technologies that may track the location of the mobile terminals may be used. In addition, at least one of the GPS satellites 300 may selectively or additionally handle satellite DMB transmissions.

As one typical operation of the wireless communication system, the BSs 270 receive reverse-link signals from various mobile terminals 100. The mobile terminals 100 typically engaging in calls, messaging, and other types of communications. Each reverse-link signal received by a particular base station 270 is processed within the particular BS 270. The resulting data is forwarded to an associated BSC 275. The BSC provides call resource allocation and mobility management functionality including the coordination of soft handoff procedures between BSs 270. The BSCs 275 also route the received data to the MSC 280, which provides additional routing services for interfacing with the PSTN 290. Similarly, the PSTN 290 interfaces with the MSC 280, the MSC interfaces with the BSCs 275, and the BSCs 275 in turn control the BSs 270 to transmit forward-link signals to the mobile terminals 100.

Instant messaging (IM) service allows users in an online state on the Internet or IP to send simple messages (slip of papers, files, data, etc.) from one another in real time, and their communication is performed mainly by text.

Thus, because text is mainly used for communication in the IM service, there is a limitation in expressing their facial expressions or feelings Thus, in order to overcome such limitation, the present invention provides a method for transmitting voice and/or pictures (or images), as well as text, in a file format to a receiver side during the IM service, to allow the receiver client can conveniently reproduce the same.

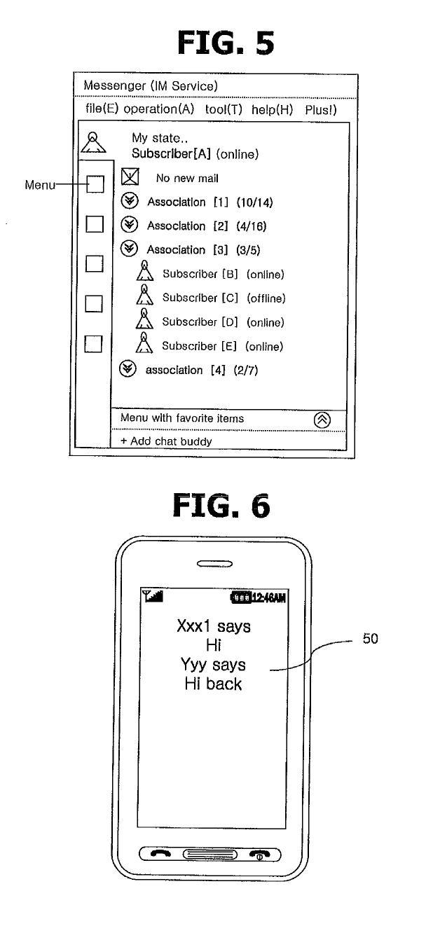

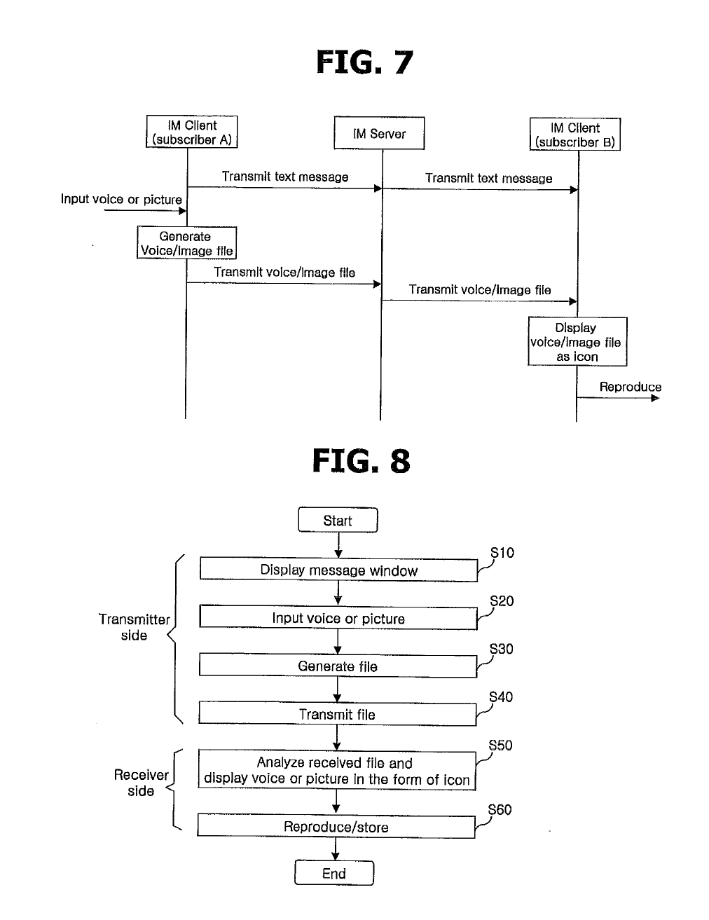

FIG. 5 is an overview of a display screen illustrating a general instant messaging (IM) service, and FIG. 6 is an overview of a display screen illustrating chatting by text with a designated client (referred to as a ‘subscriber’, hereinafter) in the IM service display screen. FIG. 7 is a flow chart illustrating a message transmission between two subscribers of the IM service according to an exemplary embodiment of the present invention.

First, when a subscriber A starts the IM service, the mobile terminal executes an IM program to display an IM messenger as shown in FIG. 5 on the display unit 151. In the IM messenger, when the subscriber A selects a desired client, e.g., a subscriber B, for communication, a message window 50 as shown in FIG. 6 is displayed on the display unit 151.

Then, as shown in FIG. 7, the subscriber A sends and receives a message by text to and from the subscriber B, and messages exchanged between the subscribers A and B are displayed in real time on the message window 50. In this state, the subscriber A (i.e., user A) may actually input voice, a picture, or a handwriting by using a pen as well as text.

If voice, a picture, or a handwriting is inputted during the IM service, the mobile terminal of the subscriber A generates a voice file or an image file with respect to the corresponding input, and transmits the same to an IM server, and the IM server transmits the received voice file or image file to a terminal of the subscriber B.

Then, the terminal of the subscriber B stores the received voice file or image file and, at the same time, displays it in the form of an icon (voice or picture) on the message window to allow the user to select the corresponding icon to check the voice or picture which has been received from the subscriber A. Namely, when the subscriber A inputs and transmits his voice, the voice icon is displayed on the message window of the receiver side message window (subscriber B), and when the subscriber B presses the corresponding icon, the subscriber A's voice is reproduced. Also, when the subscriber A draws a picture or writes something with a pen and transmits the same, the picture is displayed on the receiver side message window, and when the subscriber B presses the corresponding icon, the subscriber A's handwriting is displayed.

FIG. 8 is a flow chart illustrating a file transmission method of the mobile terminal in the IM service according to an exemplary embodiment of the present invention. Here, the clients A and B will be set as subscriber A and B or users A and B for the sake of brevity.

As shown in FIG. 8, the subscriber A may perform voice call communication or video call communication with one or more subscribers. In this state, if the subscriber A (i.e., user A) selects a menu provided in the mobile terminal to start the IM service, the controller 180 executes the IM program to display an IM messenger on the display unit 151 (S10).

On the IM messenger, the subscriber A may select, a desired subscriber, namely, the subscriber B currently in the online state and chat by text with the subscriber B through the message window 50. At this time, messages exchanged between the subscribers A and B are displayed in real time on the message window 50.

In this state, the subscriber A may actually input his voice to the mobile terminal or input a picture (picture, drawing, etc.) or his handwriting with a pen (S20). The inputted voice or picture may be detected by a microphone or a touch sensor and inputted to the controller 180.

The controller 180 may perform a controlling operation for recording, editing, deleting, adding and storing the inputted voice, and convert the voice and the picture data into a file format to transmit the same to the subscriber B (S30).

In this manner, when the voice or image data (picture, handwriting, screen image) is inputted during the IM service, the controller 180 generates the voice or image file with respect to the corresponding input, and transmits the same to the IM server (S40). Upon receiving the voice file or image file, the IM server transmits the voice file or image file to the terminal of the subscriber B.

Upon receiving the voice file or image file from the IM server, the controller 180 of the subscriber B analyzes the received voice file or image file and displays the corresponding file in the form of an icon (voice icon or picture icon) on the display unit 151 (S50). Then, the subscriber B may select the corresponding icon to reproduce the voice of the subscriber A or reproduce the picture or image, or may store the corresponding file according to a storage selection of the subscriber A (S60).

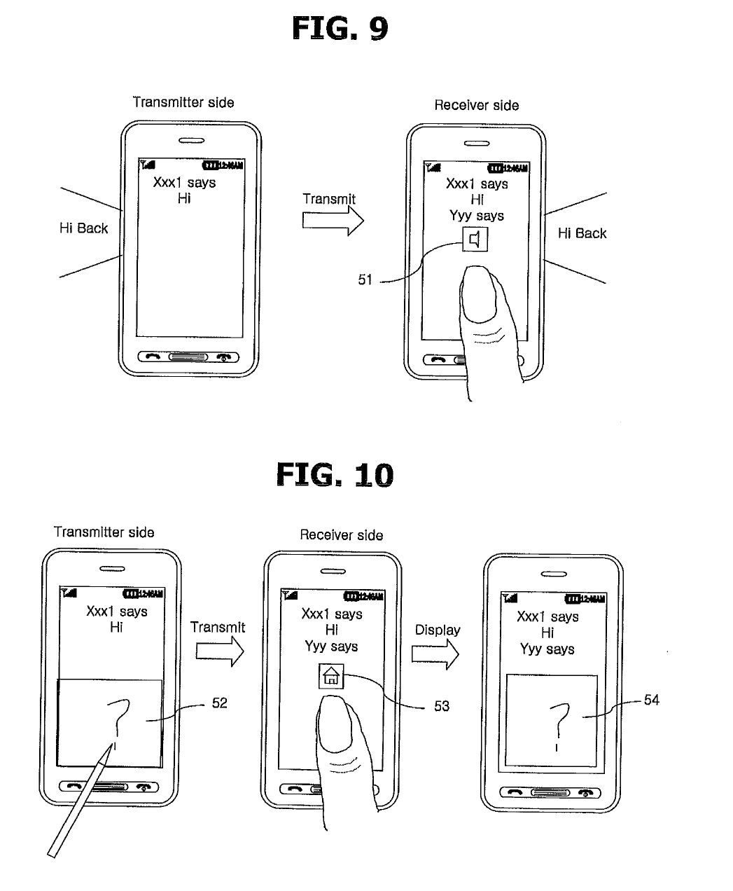

FIG. 9 is overviews of display screens illustrating a voice transmission method during an IM service according to an exemplary embodiment of the present invention.

As shown in FIG. 9, when the subscriber inputs a particular key or touches the message window during the IM service and inputs his voice (‘Hi Back’), the controller 180 converts the inputted voice into a file and transmits the file. Then, the mobile terminal, specifically, the controller 180, of the subscriber B analyzes the received voice file and displays a voice icon 51 on the display unit 151.

Then, the subscriber B selects the voice icon 51 to reproduce the voice of the subscriber A.

When the voice file is received, the controller 180 of the receiver side may immediately reproduce a storage/non-storage item included in the corresponding file, display the voice file in the form of an icon, or reproduce one time and then display it in the form of an icon. Preferably, the storage/non-storage item may include an item for immediately outputting received voice data or image data, an item for displaying the received voice data or image data in the form of an icon without outputting the received voice data or image data, and an item for outputting the received voice data and image data one time and displaying the received voice data and image data in the form of icon. Also, the controller 180 may display the received file in the form of an animation character or the name indicating the subscriber A as well as the icon.

FIG. 10 is overviews of display screens illustrating inputting and transmitting an image during an IM service according to an exemplary embodiment of the present invention.

With reference to FIG. 10, when the subscriber A inputs a particular picture or handwriting with a pointer (stylus, user's finger, etc.) on a touch region 52 of the mobile terminal during the IM service, the controller 180 converts the inputted picture or handwriting into a file and transmits the same to the terminal of the subscriber B.

The mobile terminal, specifically, the controller 180, of the subscriber B analyzes the received picture file and displays a picture icon 53 on the display unit 151. In addition, the controller 180 may immediately display the received picture file, or display it one time and then display the picture file in the form of an icon. Also, the controller 180 may display the received file in the form of an animation character or name indicating the subscriber A as well as in the form of an icon.

When the subscriber B selects the picture icon 53, the controller 180 displays the picture or handwriting which has been inputted by the subscriber A on a pop-up window 54.

The IM service method of the mobile terminal according to an exemplary embodiment of the present invention will now be described in detail.

When the IM service is provided, a voice input format may be discriminated according to a point when the IM is performed. The IM may be simultaneously performed while performing a voice call or video call. Thus, while performing voice call or video call, the IM may be additionally performed to transmit voice data (or image data) only to a particular subscriber (subscribers) without informing other subscribers. In this point of view, the voice input format may be divided into a case when IM is performed, a case when IM is performed during voice call communication, and a case where IM is performed during video call communication.

1) When IM is Performed

When IM is performed, only the voice data of the transmitter side is an object of file generation.

When a voice ‘Hi Back’ is received from the subscriber A while IM is being performed, the controller 180 generates a file by using the voice of the subscriber A. The generated file is stored in the form of name or emoticon according to a user setting. If there is no particular file setting, it follows a default setting.

When the voice file is generated, the controller 180 additionally provides a storage selection menu with respect to the receiver side to the subscriber A, so that the subscriber A can set such that when the generated file is transferred to the subscriber B, the corresponding file is simply displayed on the message window 50 and then automatically deleted, or it is stored and then reproduced.

2) When IM is Performed During Voice Call Communication

When IM is performed during voice call communication, the voice data of the receiver side and the voice data of the transmitter side, as well as the voice data of the transmitter side, are objects of file generation. Namely, like when the IM is performed, during voice call communication, the voice of the subscriber A is recorded and a file is then generated, or the voice of the subscriber A is recorded together with the voice received from the subscriber B and a corresponding file is then generated.

3) When IM is Performed During Video Call Communication

When IM is performed during video call communication, the voice data of the transmitter side plus a screen image, the voice data of the transmitter side plus the voice data of the receiver side plus the screen image, and the voice data of the receiver side plus the screen image, as well as the voice data of the transmitter side, are objects for file generation. That is, during the video call communication, not only the voice of the subscribers A and B may be recorded to generate a file, but also an image (or voice) appearing on the current screen may be included to generate a file according to a selection of the subscriber A.

For example, the voice of the user A may be simply transmitted to the subscriber B, chat content between the subscriber A and/or the subscriber B is recorded and a portion or the entirety of the message window may be selected (through a touch input or dragging) to generate a file.

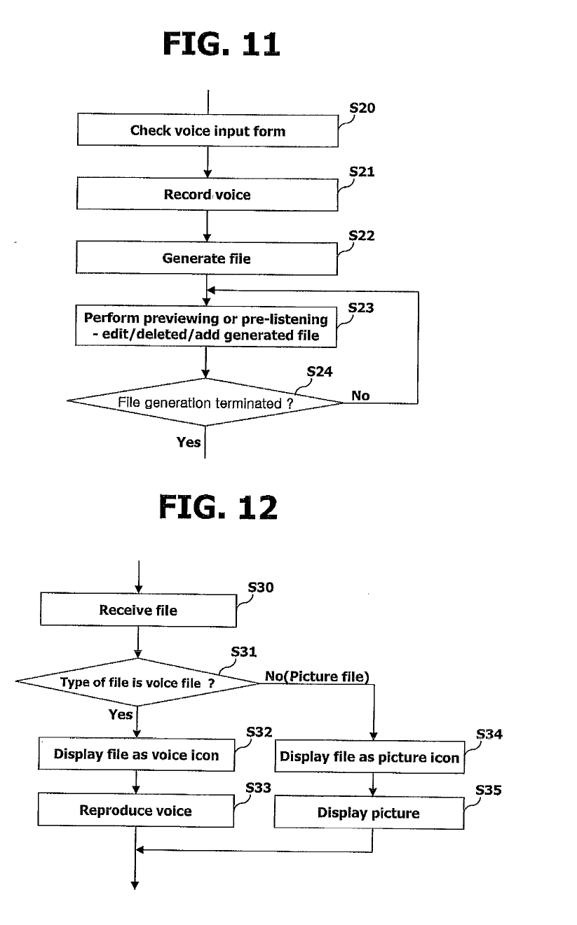

FIG. 11 is a flow chart illustrating the process of generating a voice file during an IM service according to an exemplary embodiment of the present invention.

As shown in FIG. 11, the subscriber A may select an input form of the voice (S20). The subscriber A may select an input form according to a type of a call he wants to perform at an early stage when the IM service starts.

After the input form of the voice is selected and a particular key is inputted or a message window is touched, when a voice is inputted, the controller 180 starts an operation for recording the voice (S21). In this case, the voice recording includes the voice (other voice) of the subscriber A and the voice of the subscriber B.

In addition, in case of video call, when the subscriber A drags the message input window, the controller 180 may select the entire screen to transmit it together with the voice or transmit a portion of an image selected according to a screen touch together with the voice.

During the voice call communication (or video call communication), the subscriber A may select a proper one from among the voice of the transmitter side, the voice of the receiver side, the voice of the receiver side plus the voice of the transmitter side, the voice of the transmitter side plus an image, the voice of the transmitter side plus the voice of the receiver side plus an image, and the voice of the receiver side plus an image, and change or select a voice input form.

Once the voice recording or image (or picture) selection is completed, the controller 180 generates a voice or image file (S22) and displays the created file on the display unit 151 to allow the subscriber A to check whether recording has been properly performed or whether the image has been properly selected, rather than immediately transmitting the file.

Accordingly, the subscriber A can delete or edit (file length, input form) the particular file upon viewing displayed content, or may perform pre-listening or previewing on the voice and image (S23).

When file generation is terminated, the controller 180 transmits the corresponding file to the subscriber B, and if file generation is not terminated yet, the step S23 is performed again (S24).

In a different exemplary embodiment of voice recording, voice may be transmitted along with an emoticon indicating each subscriber. Namely, in the messenger as illustrated in FIG. 5, when an emoticon of a particular subscriber (D) is selected, the controller 180 recognizes that recording starts, records input voice of the subscriber (D), and immediately transmits it.

FIG. 12 is a flow chart illustrating the process of a method of displaying a reception file at a receiver side according to an exemplary embodiment of the present invention.

As shown in FIG. 12, when a certain file is received during IM, the controller 180 of the receiver side determines a type of the received file (S30, S31).

If the received file is a voice file, the controller 180 displays the received as a voice icon on the message window (S32), and if the received file is a picture file, the controller 180 displays a picture icon (S34). At this time, the controller 180 checks a storage/non-storage item included in the reception file and displays the received file (voice or picture file) on the message window 50 of the terminal of the receiver side in the three types as follows:

1) The received file is immediately outputted (reproduced or displayed) upon receipt of it.

2) The received file is displayed in a file form (icon) upon receipt of it (outputted when the icon is selected)

3) The received file is immediately outputted one time and then displayed in a file form.

Thereafter, when the user B selects the voice icon or the picture icon, the controller 180 reproduces the voice or displays the picture according to a selection of the subscriber B (S33, S35).

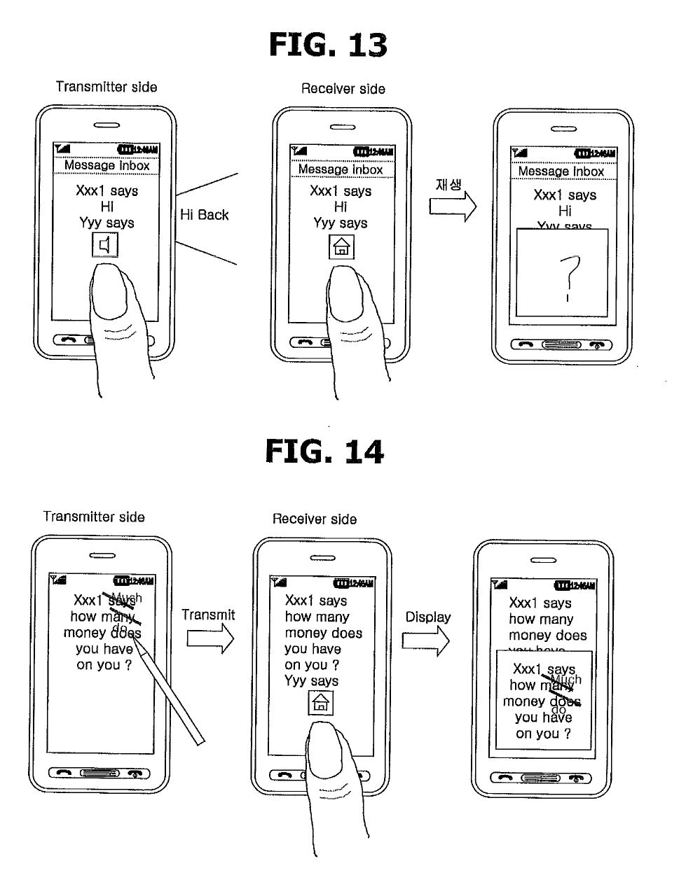

FIG. 13 is overviews of display screens illustrating a reception file at the receiver side according to an exemplary embodiment of the present invention.

As described above, the file (voice or picture file) displayed on the message window is stored in the message inbox. In this case, the file may be displayed one time and then deleted, or after displaying of the file is terminated, the file is immediately stored in the message inbox, according to a setting of a storage/non-storage item at the transmitter side.

When it has been set such that the file is stored in the message inbox, the controller 180 may separately store only the file, store only the message excluding the file, or store both the file and the message.

Accordingly, the subscriber B may search the message inbox as necessary to select the voice icon or the picture icon to reproduce the voice the subscriber A has sent or display the picture the subscriber A has sent.

FIG. 14 is overviews of display screens illustrating utilization of a method of inputting and transmitting an image during an IM service according to an exemplary embodiment of the present invention.

As shown in FIG. 14, the subscriber A may correct a message that the subscriber B has transmitted. When the subscriber A transmits the corrected message to the subscriber B, the controller 180 stores a corrected portion as a picture together with the writing of the subscriber B and transmits it in a file form to the subscriber B.

Upon receiving the picture file, the controller 180 of the receiver side terminal displays the received file in a picture icon form on the message window.

Accordingly, when the subscriber B selects the picture icon, the controller 180 displays the corrected portion together with the writing of the subscriber B on a pop-up window.

As so far described, according to the exemplary embodiments of the present invention, when the IM service starts, the user may input text to the message window to chat with one or more subscribers, and when a voice or image (picture, writing, etc.) is inputted while text is inputted, the inputted voice or image is converted into files, transmitted to a counterpart subscriber and displayed in an icon form, so that the counterpart subscriber can select the displayed icon to check the voice or picture.

In an exemplary embodiment of the present invention, the above-described method can be implemented as software codes that can be read by a computer in a program-recorded medium. The computer-readable medium may include various types of recording devices in which data that can be read by a computer system is stored. The computer-readable medium may include a ROM, a RAM, a CD-ROM, a magnetic tape, a floppy disk, an optical data storage device, and the like. The computer-readable medium also includes implementations in the form of carrier waves or signals (e.g., transmission via the Internet). In addition, the computer may include the controller 180 of the terminal.

As the exemplary embodiments may be implemented in several forms without departing from the characteristics thereof, it should also be understood that the above-described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

What is claimed is:

1. A method for transmitting a file of a mobile terminal in an instant messaging (IM) service, the method comprising:
when an IM service starts, displaying a message window;
chatting by text with one or more subscribers on the message window; inputting voice data or image data while inputting text; and
converting the inputted voice data or image data into files and transmitting the voice file or image file to the counterpart subscribers.

2. The method of claim 1, wherein the image data comprises a picture, a handwriting, and a screen image.

3. The method of claim 1, wherein, when only the IM service is provided, the voice data is voice data of a transmitter side.

4. The method of claim 1, wherein when the IM service is provided during voice call communication, the voice data comprises the voice data of the transmitter side, voice data of a receiver side, and the voice data of the transmitter side plus the voice data of the receiver side.

5. The method of claim 1, wherein when the IM service is provided during video call communication, files are made for voice data of the transmitter side, for voice data plus image data of the transmitter side, for the voice data of the transmitter side plus the voice data and image data of the receiver side, and for voice data and image data of the receiver side.

6. The method of claim 1, wherein the voice data is immediately recorded when a certain key is pressed or a touch input is applied.

7. The method of claim 1, wherein when an emoticon of a counterpart is selected, the voice data is immediately recorded and transmitted.

8. The method of claim 1, wherein the transmitting of the voice file or image file comprises:
converting the inputted voice data or image data into files; and
setting a storage/non-storage item, for the voice data file or the image data file, as to whether such should be stored at the receiver side.

9. The method of claim 8, wherein the storage/non-storage item comprises:
an item for immediately outputting received voice data or image data;
an item for displaying the received voice data or image data in the form of an icon without outputting the received voice data or image data; and
an item for outputting the received voice data and image data one time and displaying the received voice data and image data in the form of icon.

10. The method of claim 1, further comprising:
performing pre-listening or previewing on the voice data file or image data.

11. The method of claim 1, wherein the voice file or image file is displayed in the form of an icon to the counterpart subscriber.

12. A mobile terminal comprising:
a display unit configured to display a message window;
an input unit configured to input voice data or image data; and
a controller configured to provide an instant messaging (IM) service via text between two subscribers on the displayed message window, convert voice data or image data inputted during the IM service into files and transmit the voice file or image file to a counterpart subscriber.

13. The mobile terminal of claim 12, wherein the image data comprises a picture, a handwriting, and a screen image.

14. The mobile terminal of claim 12, wherein when only the IM service is provided, the voice data is voice data of a transmitter side.

15. The mobile terminal of claim 12, wherein when the IM service is provided during voice call communication, the voice data comprises the voice data of the transmitter side, voice data of a receiver side, and the voice data of the transmitter side plus the voice data of the receiver side.

16. The mobile terminal of claim 12, wherein when the IM service is provided during video call communication, files are made for voice data of the transmitter side, for voice data plus image data of the transmitter side, for the voice data of the transmitter side plus the voice data and image data of the receiver side, and for voice data and image data of the receiver side.

17. The mobile terminal of claim 12, wherein the voice data is immediately recorded and transmitted when a certain key is pressed or a touch input is applied, or when an emoticon of a counterpart is selected.

18. The mobile terminal of claim 12, wherein the controller sets a storage/non-storage item, for the voice data file or the image data file, as to whether such should be stored at the receiver side, and the voice or image file is displayed in an icon form to the counterpart subscriber.

19. The mobile terminal of claim 18, wherein the storage/non-storage item comprises:
an item for immediately outputting received voice data or image data;
an item for displaying the received voice data or image data in the form of an icon without outputting the received voice data or image data; and
an item for outputting the received voice data and image data one time and displaying the received voice data and image data in the form of icon.

20. The mobile terminal of claim 12, wherein the controller performs pre-listening or previewing on the voice data file or image data.
